(19) United States
(12) Patent Application Publication
(10) Pub. No.: US 2006/0105839 A1
(43) Pub. Date: May 18, 2006

(54) Casino game based on financial market activity

(75) Inventors: Paul Kent Graeve, Chicago, IL (US); Bradley J. McGill, Birmingham, AL (US)

Correspondence Address: Daniel H. Golub, 1701 Market Street, Philadelphia, PA, 19103, US

(73) Assignee: Delta Rangers, Inc., Birmingham, AL (US)

(21) Appl. No.: 11/069,586

(22) Filed: Mar. 1, 2005

Related U.S. Application Data
(60) Provisional application No. 60/627,820, filed on Nov. 15, 2004.

(51) Int. Cl. A63F 9/24; G06F 19/00; A63F 13/00; G06F 17/00

(52) U.S. Cl. 463/42

(57) ABSTRACT

The present invention is directed to a method used by a casino for conducting a casino game in which a plurality of players bet against each other. A set of rules is established for the game. The rules define a winner based on at least one financial market data value that fluctuates based on market activity in a financial market that is distinct from the game. Updates to the financial market data value are electronically received from a third-party data source. A forum that is electronically coupled to the third-party data source is provided where the players play the game against each other in accordance with the established set of rules and the at least one financial market data value. The casino collects a fee for conducting the game.

### FIELD OF THE INVENTION

The present invention relates generally to casino games and, in particular, to novel casino games that are based on activities in financial markets.

### BACKGROUND OF THE INVENTION

Casino gambling is a large and growing industry throughout the world. Various types of betting products and systems exist that facilitate betting on the outcome of a particular game. For example, a patron in a casino may bet on a single hand of blackjack, a pull on a slot machine, a roll of the dice, etc. Typical horse racing bets allow bettors to wager on a single horse, on several horses in a particular race or series of races. For instance, a bettor can wager on a particular horse to finish first (win), finish in the top two (place), or finish in the top three (show). A bettor may also make various combination bets with multiple horses, such as an “exacta” bet (covering the top two horses in order) or a “trifecta” bet (covering the top three horses in order). In addition, a bettor may bet on a series of races, such as the daily double (winners of two consecutive races), the pick-three (winners of three consecutive races), and the pick-six (winners of six consecutive races).

Those betting on other sports may wager, for instance, on various aspects of the outcome of a particular game, including the winning team, the point margin by which that team wins, the combined final score of both teams, and so on. Wagers of this kind are generally well-known and unexceptional. Games or events (the terms “games” and “events” are used interchangeably to connote some probabilistic occurrence) upon which wagers may be placed may be viewed as games of pure chance (e.g., a coin toss or roulette wheel spin assuming the game is a “fair” one with no intervening human or mechanical influence skewing mathematical random distributions of outcome); games of mixed skill and chance (e.g., blackjack or horse racing); or games perceived of as consisting of pure skill (e.g., soccer, chess). All these games and events are believed to be at least somewhat probabilistic in nature. That is, there is more than one possible outcome that is not preordained. Even in games that are perceived as games of pure skill, it is believed that an effectively random element (based on, e.g., weather conditions, unforeseen player injuries, etc.) is almost always present.

Slot machines or other machines for player-initiated games of skill or chance (sometimes referred to as, or including video lottery terminals or video poker games) are becoming increasingly common fixtures in numerous jurisdictions across North America and elsewhere throughout the world. Conventional slot machines have one or more “pay lines” by which to determine whether the spin is a winning one. With each spin, different symbols appear on three or more reels (such as cherries, oranges, bells, or sevens). Preset combinations of symbols on the pay line return predetermined amounts to the player (e.g., three cherries may pay five times the amount wagered). Each spin of the reels generally represents one separate wager.

Most betting systems of the prior art are similar to a pull on a slot machine or a single hand of black jack in that they are based on the outcome of a single event or game—a “one-off transaction.” An exception may be found in certain progressive or “jackpot” slot machine systems, but there are generally few means by which a player may take a betting position regarding the outcomes over time of a series or plurality of events that may or may not be related.

Like casino gambling, interest in world financial markets has grown significantly in recent years. An increasing number of small individual investors participate in these markets than ever before, and there is a growing interest among the population as to how such markets function. In addition to equities, trading in derivatives and other sophisticated financial products has matured, and new types of financial products such as exchange traded funds and hedge funds are being introduced.

Despite the growing popularity of both casino gambling and financial markets, these concepts have not previously been integrated in a casino game where players bet against each other. The present invention addresses this shortcoming in the prior art, and is directed to novel casino games that are based on activity in financial markets.

### SUMMARY OF THE INVENTION

The present invention is directed to a method used by a casino for conducting a casino game in which a plurality of players bet against each other. A set of rules is established for the game. The rules define a winner based on at least one financial market data value that fluctuates based on market activity in a financial market that is distinct from the game. Updates to the financial market data value are electronically received from a third-party data source. A forum that is electronically coupled to the third-party data source is provided where the players play the game against each other in accordance with the established set of rules and the at least one financial market data value. The casino collects a fee for conducting the game.

In some embodiments, the financial market data value corresponds to a value of a financial market instrument selected from the group consisting of: a stock, option, future, fund, bond or physical commodity. Alternatively, the financial market data value may correspond to an interest rate, index, exchange rate, or data release.

The forum where the game is played may correspond to a casino where all of the players are physically present during the game. Alternatively, the forum may correspond to an on-line forum that includes a computer network that permits communication among physically separated players during the game.

### BRIEF DESCRIPTION OF THE DRAWINGS

FIG. 1 illustrates a forum for conducting a casino game in accordance with the present invention, wherein the players are physically present in a common location during the game.

FIG. 2 illustrates an on-line forum for conducting a casino game in accordance with the present invention, wherein the players are physically separated from each other during the game.

### DETAILED DESCRIPTION OF THE PREFERRED EMBODIMENTS

The present invention includes methods and systems for creating and playing casino games that can be played in a physical gaming room or online, where players bet against other players and the elements of the game consist of, for example, actual financial instruments that are traded on various financial exchanges around the world or other data representative of the state of one or more financial markets. Financial data values that could be used in the games include any of the following: the values of financial securities, market indices, economic data or indicators, financial market data and indicators, foreign exchange rates, physical commodities and interest rates. Financial instruments which trade constantly, in significant volume, with higher than average volatility will be most attractive for use in these games as they will provide short-term movements that will keep the games exciting and fast-paced. Although in the description below, various embodiments of the present invention are described as being based on the use of financial instruments, it will be understood that each of these embodiments may be based on any financial data value such as the ones listed above.

The casino games of the present invention optionally combine elements, rules and strategies traditionally found in casino games and betting with strategies traditionally utilized in financial investing; thereby attracting players with knowledge and skills in both gambling and investing. In addition, since the players are betting against each other and not against the overall financial markets as a whole, the games have particular appeal to players who believe, for one reason or another, that they possess superior knowledge or skill in the financial markets than the other players in the game.

In casino games of the present invention, the players bet against the other players in the game, and the winnings paid to the winning players of the games consist of losses from the losing players in the games. This feature eliminates the requirement for the casino to make odds on the games, and more importantly eliminates the requirement for the casino to make odds on the underlying elements of the game, specifically the financial markets.

Among other things, the present invention allows players within a physical or online casino to gamble in a gaming format that combines both financial investment and casino gaming and betting strategies. For example, in a casino game where the players bet on who can assemble the best performing financial portfolio during a short-term time period, all the player's financial portfolios could lose value, but still the player whose portfolio performed the best, would win the game and the subsequent gambling winnings. Considering the breadth of gambling games and pari-mutuel bet combinations, there are numerous games that could be created from the combination of pari-mutuel format games and financial instruments. All such combinations are considered to be within the scope of the present invention.

In one embodiment, players are “dealt” or they assemble (based on their own financial strategies) their portfolio from a menu (for basic games simple securities, like just equities would be on the menu, for advanced games, players could choose from a wide array of options, futures, commodities, currencies, etc.). Each player then competes against the other players in the game to generate the best return on their portfolio. The game could have similar elements to other casino games. For example, players could “parlay” or “double down” additional bets as the game proceeded. The games could either be for a predefined time frame where, upon ending, players are paid out according to their position, just like a payout at the end of a hand of cards, or there could be a continuous game where each player would be paid out based on how he did vs. the other players from the time he started or “logged into” the game, to the moment he ended or “logged out” of the game.

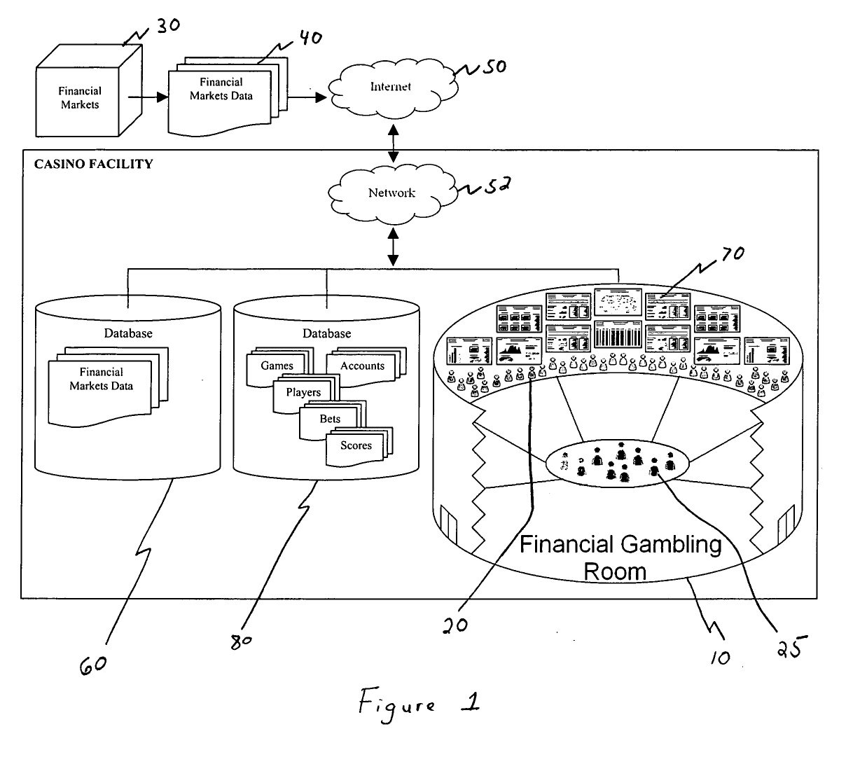

The game could be played online, or in a physical gaming room of a casino. Optionally, the game would continuously stream market and game data to the players on their respective screens (or on large LCD screens in the casino). Players online would adjust their positions via the online user-interface using their mouse and keyboards, while casino players could either have a console by which they could play the game, or the casino could even simulate a market trading floor where players would call out or hand signal their positions to casino workers (e.g., workers 25 in FIG. 1) who would make the appropriate adjustments to their portfolio as signaled.

FIG. 1 illustrates a forum for conducting a casino game in accordance with the present invention, wherein the players 20 are physically present in a common location (i.e., financial gambling room 10 of a casino) during the game. The casino establishes a set of rules for the game. The rules define one or more players 20 as winners, based on at least one financial market data value that fluctuates based on market activity in a financial market 30 that is distinct from the game. Financial market 30 corresponds, for example, to a government-regulated financial market or an over-the-counter financial market. For purposes of this description, each player 20 corresponds either to a single person or a group of persons that collectively participate in the game as a team.

Updates to the financial market data value are electronically received from a third-party data source 40 over computer networks 50, 52. Financial gambling room 10 is electronically coupled to the third-party data source 40. During the game, players 20 play and bet against each other in accordance with the established set of rules and the at least one financial market data value. The casino collects a fee for conducting the game. The financial market data value(s) used in the game optionally correspond to a value of a financial market instrument such as a stock, option, future, fund, bond or physical commodity, or a value of an interest rate, index, exchange rate, or data release. The financial data 40 provided to the casino from the third-party data source may comprise streaming financial data such as that provided by Bloomberg or other recognized financial data services.

In one embodiment, the casino subscribes to one or more financial market data services, collects financial market information including the at least one financial market data value from the market data services using computerized networks 50, 52, stores the financial market information in database 60, and displays the financial market data to the players 20 during the game on large screens 70 visible to all players 20. In an alternate embodiment (not shown), the streaming financial data is provided to each of the players on a computer screen of an individual gaming console used by the player along with other data associated with the game (e.g., current scores of other players).

Database 80 stores the gaming history of each player 20 including previous game scores, bets and winnings. As described below, the gaming history stored in database 80 is used by the casino to determine eligibility for participation in future games, tiers, or tournaments. Optionally, the stored gaming history for a player may include both past scores and winnings of the player that occurred during participation by the player in an on-line forum where the player was physically separated from other players during the game, and past scores and winnings of the player that occurred during participation by the player in a forum where the player was physically present with other players during the game. Database 80 also optionally maintains an odds book based on bets placed by the players 20 and displays the results to the players on screens 70 prior to commencement of a game. In this embodiment, payouts at the end of the game are based on the odds book.

A variety of fees may be charged by the casino for conducting or hosting the game. For example, the casino may charge an initial fee (or an entry fee) to each player 20 who participates in the game. A fee corresponding to a percentage of amounts wagered by the players 20 during the game can also be collected by the casino. Alternatively, the fee collected by the casino may correspond to a fixed fee associated with each round of the game, or a percentage of winnings.

The casino game of the present invention optionally utilizes a gaming element with an outcome based on chance such as, for example, playing cards, dice, or a wheel. In these embodiments, the outcome of the game is determined in accordance with the at least one financial market data value that fluctuates during the game and an outcome of the gaming element. The outcome of the game may further be determined in accordance with the betting strategy of the winner or other players 20.

In some embodiments of the present invention, the outcome of the game is determined in accordance with an accuracy by which the winner predicts a future value of the at least one financial market data value (e.g., the future value of a stock, bond or interest rate). The outcome of the game may also be fully or partially determined by the amount of money a player has won from other players in the game.

In one embodiment where, for example, each player holds a portfolio of financial instruments, each player assigns varying weights of importance to one or more financial data values or predictions about how each of the financial instruments will perform during the game, and the weights are used to calculate a score for the player.

During the game, the score of each player, the values/identities of the financial instruments or portfolio held by each player, and/or values representing the accuracy of predictions made by each player about how each of the financial instruments held by the player will perform during the game, may be displayed to all other players during the game on screens 70 or individual gaming consoles (not shown). Alternatively, some or all of this information about the position of a player in the game may be maintained in secret from one or more other players during one or more segments of the game, or during all of the game. For example, some or all of this information for a particular player may only be revealed to other players during one or more intermediate segments of the game. In other embodiments, the players might not know the score of each player, the values/identities of the financial instruments or portfolio held by each player, and/or values representing the accuracy of predictions made by each player about how each of the financial instruments held by the player will perform during the game, until the very end of the game. The casino may establish the game rules such that a player is eliminated from the game when the score of the player or a financial market data value reaches or falls below a predetermined threshold.

As mentioned above, the rules of the game may provide for the random assignment of financial instruments to each player (e.g., each player is dealt a set of cards by the casino, where each of the cards corresponds to a different financial instrument). In some of these embodiments, the game rules may provide for exchange, during at least one game interval, of one or more financial instruments initially assigned at random to each player for one or more further financial instruments assigned at random to the player. For example, a player may “discard” one of the financial instruments previously “dealt” to the player at which time another financial instrument will be “dealt” to the player. The game rules may also provide for the elimination of financial instruments that are performing poorest at one or more intervals during the game, and players holding eliminated financial instruments are either eliminated from the game, or are permitted to re-pick (or are dealt) one or more financial instruments from remaining financial instruments in the game.

The casino may maintain odds for the game (e.g., odds that each player will win) and may periodically recalculate the odds for each player during the game. In these embodiments, the rules established by the casino may permit each player to adjust their positions or predictions during the game, and a player who selects a correct position or makes a correct prediction will win a varying amount depending upon when the player selected the correct position or made the correct prediction. For example, the winnings of a player who selects a correct position or makes a correct prediction will decrease over time depending on when the player selected the correct position or made the correct prediction.

In some embodiments, players must increase their bets at certain intervals of the game in order to remain in the game, or players must match a bet of at least one other player at certain intervals of the game in order to remain in the game. The rules may also set a minimum wager, a maximum wager, or both, for each player in the game. The rules established by the casino may also provide each player with an ability to wager money in order to purchase an option that permits the player to trade-out one financial instrument for another financial instrument held by the player, change a weighting or prediction assigned to a financial instrument, increase a bet, or purchase insurance against an unfavorable outcome.

The rules may be established such that the game ends after a predetermined period of time has elapsed. Alternatively, the game may have an indefinite end time. For example, the casino may pay each player when the player leaves the game or at one or more intermediate points during the game, based on the relative performance of the player compared to the other players in the game, from the time the player joined the game to a later time. In other embodiments, the game ends when a score of a player reaches a predetermined threshold, or when the value of a particular financial instrument or other financial data value reaches a predetermined threshold.

Based on information stored in database 80 and criteria established by the casino, the casino may establish one or more gaming tiers or levels for players to compete. A player's ability to compete within a tier or level could be based upon the player's historical performance or winnings. Players move between different tiers or levels as they reach a particular threshold which promotes the player into a higher tier or level, or demotes the player down to a lower tier or level. The gaming tiers or levels may be established to promote or demote players from higher or lower stakes games, or in a tournament format where winning players continue to participate in the tournament, and losing players are eliminated from the tournament. In one embodiment, each gaming tier or level specifies one or more maximum bets that each player may make.

The game rules may permit players to bet on the relative performance of a common predefined set of financial instruments over a predetermined set of time. In these embodiments, the rules may provide that the winners of the game are those players who made correct predictions and the winnings paid to those players will include losses from the players with the incorrect predictions. In addition, the rules may permit players to bet on which financial instruments from the common set will perform worst during the game. In an example of such a game, each player ranks the common set of financial instruments from 1 to X, where X equals the total number of financial instruments in the set, and places a bet that the performance of the financial instruments in the common set during a predetermined period of time will rank in the same order as the rankings made by the player. The rules may also permit each player to place a combined bet on the financial instruments from the common set that will perform best, second best and third best, during a predetermined period of the game or during successive predetermined periods of the game. Such bets would be analogous to “win”, “place” or “show” bets, or exacta or trifecta bets in the case of horse racing. The rules may also permit each player to place a combined bet on the financial instruments from the common set that will perform worst, second worst and third worst, during a predetermined period of the game.

The payouts made by the casino to the players at the end of the game may vary. For example, a first place winner of the game can be paid the total amount of the bets placed during the game by all the players, minus the fee collected by the casino. Alternatively, the first place winner of the game will receive the highest share of the total bets placed during the game by all the players, minus the fee collected by the casino, and some or all of the other participants receive smaller shares of the total bets placed during the game by all the players. In a still further embodiment, each player that made a correct prediction about the performance of a financial instrument wins and all other players lose.

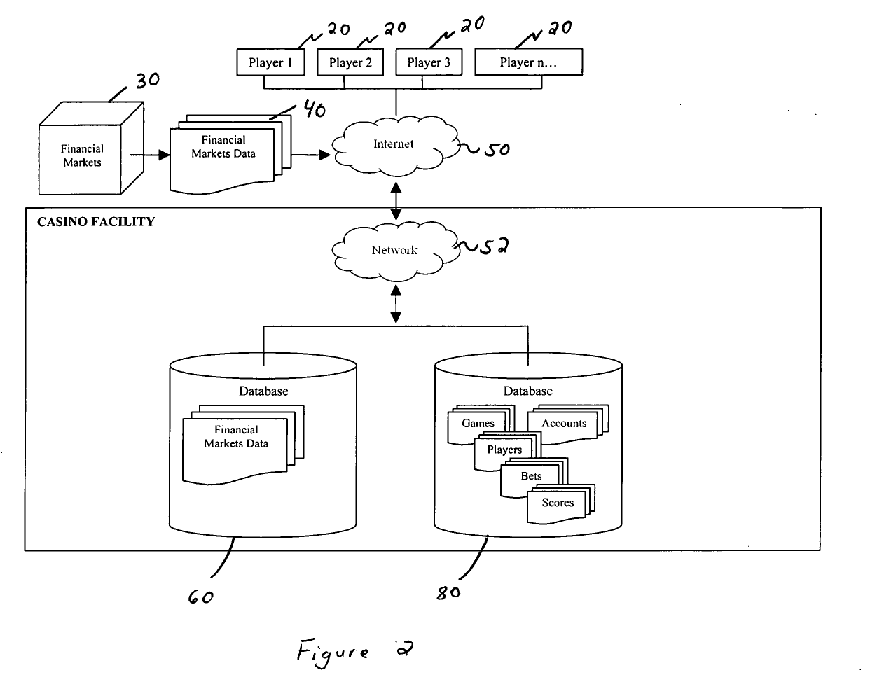

FIG. 2 illustrates an on-line forum for conducting a casino game in accordance with the present invention. In contrast to FIG. 1, in the embodiment of FIG. 2, players 20 are physically separated from each other during the game. Rather than all the players being physically present in the same gambling room, each of the players 20 in this embodiment is connected to the other players and the casino by computer networks 50, 52. In the online embodiment shown, each player 20 creates an account within the online forum for accessing the game over the computer network. During creation of the online account, each player 20 establishes an online payment method for funding bets, such as a credit card, bank draft or PayPal® services. Except for the fact that the players are located remotely from each other, the game forum shown in FIG. 2 functions substantially the same as the forum of FIG. 1. It will be understood that various combinations of the game forums shown in FIGS. 1 and 2 are possible, such that some of the players will be physically present in the gambling room 10 while other players will be connected to the gambling room 10 remotely over computer networks 50, 52.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

1. A method used for conducting a game in which a plurality of three or more players bet against each other, comprising:
establishing a set of rules by which the players compete against each other during the game, wherein the rules determine a game performance for each of the plurality of players based on at least one financial market data value that fluctuates based on market activity in a financial market that is distinct from the game; and wherein the rules define a winning player based on the game performance of the winning player relative to the game performance of other ones of said plurality of players;
electronically receiving updates to the financial market data value from a third-party data source;
providing a forum, electronically coupled to the third-party data source, where the players play the game against each other in accordance with the established set of rules and the at least one financial market data value, wherein the plurality of players bet against each other during the game; and
collecting, by a sponsor of the game, a fee for conducting the game;
wherein each of the plurality of players is different from the sponsor of the game.

2. The method of claim 1, wherein financial market data value corresponds to a value of a stock, option, future, fund, bond, physical commodity, interest rate, index, exchange rate, or data release.

3. The method of claim 1, wherein all of the players are physically present in the forum during the game.

4. The method of claim 1, wherein the forum is an on-line forum that comprises a computer network that permits communication with physically separated players during the game.

5. The method of claim 1, further comprising the step of providing streaming financial data including the at least one financial market data value during the game.

6. The method of claim 5, further comprising the steps of subscribing to one or more financial market data services, collecting financial market information including the at least one financial market data value from said market data services using a computerized network, storing the financial market information, and displaying the financial market data to the players during the game.

7. The method of claim 6, wherein the streaming financial data is provided to each of the players on a computer screen along with other data associated with the game.

8. The method of claim 7, wherein the streaming financial data is provided to each player on a computer screen of an individual gaming console used by said player.

9. The method of claim 7, wherein the streaming financial data is provided to all players via one or more large screens visible to multiple players.

10. The method of claim 4, wherein a player creates an account within the online forum for accessing the game over the computer network.

11. The method of claim 10, wherein during creation of the online account, the player establishes an online payment method for funding bets.

12. The method of claim 11, wherein the online payment method is selected from the group consisting of: credit card, bank draft or PayPal® services.

13. The method of claim 1, wherein the forum stores the gaming history of players including game scores and winnings.

14. The method of claim 13, wherein the stored gaming history is used by the forum to determine eligibility for participation in future games, tiers or tournaments.

15. The method of claim 14, wherein the stored gaming history for a player including gaming history includes past scores and winnings of the player that occurred during participation by the player in an on-line forum where the player was physically separated from other players during the game, and past scores and winnings of the player that occurred during participation by the player in a forum where the player was physically present with other players during the game.

16. The method of claim 1, wherein a computerized financial gaming system operated by the sponsor of the game maintains an odds book based on bets placed by the players and displays the results to the players prior to commencement of a game, and wherein payouts at the end of the game are based on the odds book.

17. The method of claim 1, wherein the fee collected by the sponsor of the game comprises an initial fee paid by all players who wish to participate in the game.

18. The method of claim 1, wherein the fee collected by the sponsor of the game corresponds to a percentage of amounts wagered by the players during the game.

19. The method of claim 1, wherein the fee collected by the sponsor of the game corresponds to a fixed fee associated with each round of the game.

20. The method of claim 1, wherein the fee collected by the sponsor of the game corresponds to a percentage of winnings.

21. The method of claim 1, wherein the rules utilize a gaming element with an outcome based on chance.

22. The method of claim 21, wherein the gaming element is selected from the group consisting of cards, dice, or a wheel.

23. The method of claim 22, wherein the outcome of the game is determined in accordance with the at least one financial market data value that fluctuates during the round and an outcome of the gaming element.

24. The method of claim 23, wherein the outcome of the game is further determined in accordance with a betting strategy of the winner.

25. The method of claim 1, wherein an outcome of the game is determined in accordance with an accuracy by which the winner predicts a future value of the at least one financial market data value.

26. The method of claim 1, wherein the outcome of the game is fully or partially determined by the amount of money a player has won from the other players in the game.

27. The method of claim 1, wherein the financial market is a government-regulated financial market.

28. The method of claim 1, wherein the financial market is an over-the-counter financial market.

29. The method of claim 1, wherein each player assigns varying weights of importance to one or more financial data values or predictions, and the weights are used to calculate a score for the player.

30. The method of claim 1, wherein a score of each player is displayed to all other players during the game.

31. The method of claim 1, wherein values of one or more financial data values or positions associated with each player are displayed to all other players during the game.

32. The method of claim 1, wherein values of one or more financial predictions associated with each player are displayed to all other players during the game.

33. The method of claim 1, wherein a score of a first player is known to the first player and unknown to all other players during at least a portion of the game.

34. The method of claim 33, wherein a score of the first player is unknown to all other players until the end of the game.

35. The method of claim 33, wherein a score of the first player is unknown to all other players except during one or more intermediate segments of the game.

36. The method of claim 1, wherein values of one or more financial instruments or positions associated with a first player are known to the first player and unknown to all of the other players in the game during at least a portion of the game.

37. The method of claim 36, wherein values of one or more financial instruments or positions associated with the first player are unknown to all of the other players in the game until the end of the game.

38. The method of claim 36, wherein values of one or more financial instruments or positions associated with the first player are unknown to all of the other players in the game except during one or more intermediate segments of the game.

39. The method of claim 1, wherein values of one or more financial predictions associated with a first player are known to the first player and unknown to all of the other players in the game during at least a portion of the game.

40. The method of claim 39, wherein values of one or more financial predictions associated with the first player are unknown to all of the other players until the end of the game.

41. The method of claim 39, wherein values of one or more financial predictions associated with the first player are unknown to all of the other players in the game except during one or more intermediate segments of the game.

42. The method of claim 1, wherein the rules provide for a random assignment of one or more financial instruments to each player in the game.

43. The method of claim 42, wherein the rules provide for exchange, during at least one game interval, of one or more financial instruments initially assigned at random to each player for one or more further financial instruments assigned at random to the player.

44. The method of claim 1, wherein players must increase their bets at certain intervals of the game in order to remain in the game.

45. The method of claim 1, wherein players must match a bet of at least one other player at certain intervals of the game in order to remain in the game.

46. The method of claim 1, wherein the rules provide each player with an ability to wager money in order to purchase an option that permits the player to trade-out one financial instrument for another financial instrument, change a weighting assigned to a financial instrument, change a prediction, increase a bet or purchase insurance.

47. The method of claim 1, wherein odds for the game are periodically recalculated during the game and the rules permit each player to adjust their positions or predictions during the game, and wherein a player who selects a correct position or makes a correct prediction will win a varying amount depending upon when the player selected the correct position or made the correct prediction.

48. The method of claim 47, wherein the winnings of a player who selects a correct position or makes a correct prediction decrease over time depending on when the player selected the correct position or made the correct prediction.

49. The method of claim 48, wherein financial instruments that are performing poorest in the game are eliminated at one or more intervals during the game, and players holding eliminated financial instruments are either eliminated or permitted to re-pick one or more financial instruments from remaining financial instruments.

50. The method of claim 49, wherein players are required to pay a fee in order to re-pick one or more financial instruments from remaining financial instruments.

51. The method of claim 1, wherein the rules comprise a minimum wager, a maximum wager, or both, for each player in the game.

52. The method of claim 1, wherein the game ends after a predetermined period of time has elapsed.

53. The method of claim 1, wherein the game has an indefinite end time.

54. The method of claim 53, wherein the sponsor of the game pays each player when the player leaves the game or at one or more intermediate points during the game, based on the relative performance of the player compared to the other players in the game, from the time the player joined the game to a later time.

55. The method of claim 1, wherein the game ends when a score of a player reaches a predetermined threshold.

56. The method of claim 1, wherein the game ends when the financial market data value reaches a predetermined threshold.

57. The method of claim 1, wherein a player is eliminated from the game when the score of the player reaches or falls below a predetermined threshold.

58. The method of claim 1, wherein the rules further comprise one or more gaming tiers or levels for players to compete, and a player's ability to compete within a tier or level is based upon the past game performance or winnings of the player.

59. The method of claim 58, wherein players move between different tiers or levels as they reach a particular threshold which promotes the player into a higher tier or level, or demotes the player down to a lower tier or level.

60. The method of claim 58, wherein the gaming tiers or levels are established in a tournament format where winning players continue to participate in the tournament, and losing players are eliminated from the tournament.

61. The method of claim 1, wherein each player corresponds to a group or team of persons participating in the game, and the group or team participates in the game as though they were a single player.

62. The method of claim 1, wherein an outcome of the game is fully or partially determined by the accurateness of each player's predictions concerning the performance of one or more financial instruments selected from among a common predetermined set of financial instruments.

63. The method of claim 1, wherein players bet on the relative performance of a common predefined set of financial instruments over a predetermined set of time.

64. The method of claim 63, wherein winners of the game comprise those players who made correct predictions and the winnings paid to those players include losses from the players with the incorrect predictions.

65. The method of claim 63, wherein players can also bet on which financial instruments from the common set will perform worst during the game.

66. The method of claim 65, wherein each player can place a combined bet on the financial instruments from the common set that will perform worst, second worst and third worst, during a predetermined period of the game.

67. The method of claim 63, wherein each player ranks the common set of financial instruments from 1 to X, where X equals the total number of financial instruments in the set, and places a bet that the performance of the financial instruments in the common set during a predetermined period of time will rank in the same order as the rankings made by the player.

68. The method of claim 63, wherein each player can place a combined bet on the financial instruments from the common set that will perform best, second best and third best, during a predetermined period of the game.

69. The method of claim 63, wherein each player can place a combined bet on the financial instruments from the common set that will perform best during successive predetermined periods of the game.

70. The method of claim 1, wherein a first place winner of the game is paid the total amount of the bets placed during the game by all the players, minus the fee collected by the sponsor of the game.

71. The method of claim 1, wherein the first place winner of the game receives the highest share of the total bets placed during the game by all the players, minus the fee collected by the sponsor of the game, and some or all of the other participants receive smaller shares of the total bets placed during the game by all the players.

72. The method of claim 1, wherein each player that made a correct prediction about the at least one financial market data value wins and all other players lose.

73. A method used for conducting a game in which a plurality of players bet against each other, comprising:
establishing a set of rules by which the players compete against each other during the game, wherein the rules determine a game performance for each of the plurality of players based on at least one financial market data value that fluctuates based on market activity in a financial market that is distinct from the game; and wherein the rules define a winning player based on the game performance of the winning player relative to the game performance of at least one other of said plurality of players;
electronically receiving updates to the financial market data value from a third-party data source;
providing a forum, electronically coupled to the third-party data source, where the players play the game against each other in accordance with the established set of rules and the at least one financial market data value, wherein the plurality of players bet against each other during the game; and
collecting, by a sponsor of the game, a fee for conducting the game;
wherein each of the plurality of players is different from the sponsor of the game; and
wherein each bet placed by the plurality of players is retained solely by the player placing the bet until the winning player is determined.

74. A method used for conducting a game in which a plurality of players bet against each other, comprising:
establishing a set of rules by which the players compete against each other during the game, wherein the rules determine a game performance for each of the plurality of players based on at least one financial market data value that fluctuates based on market activity in a financial market that is distinct from the game; and wherein the rules define a winning player based on the game performance of the winning player relative to the game performance of at least one other of said plurality of players;
electronically receiving updates to the financial market data value from a third-party data source;
providing a forum, electronically coupled to the third-party data source, where the players play the game against each other in accordance with the established set of rules and the at least one financial market data value, wherein the plurality of players bet against each other during the game; and
collecting, by a sponsor of the game, a fee for conducting the game;
wherein each of the plurality of players is different from the sponsor of the game; and
wherein there is a risk of loss associated with the game, and the risk of loss is held solely by the plurality of players.
